(19) United States
(12) Patent Application Publication
(10) Pub. No.: US 2025/0155237 A1
(43) Pub. Date: May 15, 2025

(54) ADJUSTABLE DIAMETER PNEUMATIC COMPARATOR FOR MEASURING BORE DIAMETERS

(71) Applicant: Sunnen Products Company, St. Louis, MO (US)

(72) Inventor: Daniel R. Cloutier, Clive, IA (US)

(21) Appl. No.: 18/928,801

(22) Filed: Oct. 28, 2024

Related U.S. Application Data
(60) Provisional application No. 63/599,139, filed on Nov. 15, 2023.

(51) Int. Cl. G01B 13/10

(52) U.S. Cl. CPC G01B 13/10

(57) ABSTRACT

Pneumatic comparator probes for engaging internal diameters of bores are provided herein. Pneumatic comparator probes include a probe body configured to contact a bore to be measured and a measuring component moveably connected to the probe body. The measuring component includes a port through which pressurized air passes when the pneumatic comparator is in use. The pneumatic comparator probes also include a variable separating mechanism moveably connected to the probe body, and movement of the variable separating mechanism adjusts a position of the measuring component in a direction of diametrical expansion relative to the probe body. Pneumatic comparator probe systems are also provided that are capable of holding and facilitating precise adjustment of the pneumatic comparator probes. Further provided are methods of measuring the bore size of a workpiece using the pneumatic comparator probe systems.

### FIELD OF THE TECHNOLOGY

The present technology relates to methods, systems and tools for measuring bores, and more particularly to pneumatic comparator probes, tools and methods for measuring bores where the probe is adjustable in diameter.

### BACKGROUND

The pneumatic comparator as a means for high precision dimensional measurement has been in use for many years. The pneumatic comparator as a means for high precision dimensional measurement can be traced back to at least the early 1930's, with French patent FR 722685 and its U.S. counterpart U.S. Pat. No. 1,971,271. Since then, the pneumatic comparator has become a common device for precision dimension measurement, especially for the measurement of the internal diameters of bores where space constraints limit the options available for measurement.

The measurement technique of using a pneumatic comparator generally consists of supplying air (or another gas) at some pressure to a “port”, i.e. a small port where the air escapes the pressurized system. When that port is placed very near, but not touching, the physical object that is to be measured then the flow of the air escaping is partially restricted. The restricted flow rate of the air escaping the port is a very precise and repeatable function of the thickness of the gap between the port and the object being measured. Upstream of the port can be some means of precisely measuring the flow rate of the air. Usually this involves measuring the pressure differential as the flow passes through an appropriately sized orifice, but can be any typical means that would be reliably sensitive to changes in the rate of air flow.

As the air flow measured is a function of the thickness of the air gap at the port near the measured object, it is a direct measurement of that gap which is not actually a dimension of interest on the measured object. Therefore, some measurement master must be used to calibrate, i.e. associate the measured gap to an actual dimension of interest.

As this technique effectively compares a gap between the port and the measured object to the gap that was seen when the master was sensed, these systems are therefore referred to as “comparators” and in particular “pneumatic comparators”. These are also commonly referred to as “air gages”, although in this context these should not be confused with instruments, such as pressure gages, which are used to measure some property of air.

A very common use of an air gage is to measure the diameter of a bore in a manufactured workpiece. These are particularly useful for relatively small bores as space constraints often preclude the use of other common high precision measuring techniques. The present invention discusses the measurement of such “bores” or “inside diameters”, however it should be noted that this invention would not be limited to circular bores. Slightly modified probes could be made to measure, for example, the size of an internal hexagonal cavity. The discussion that follows should be understood to extend to such unusual shapes where it would be useful to use a probe or instrument appropriately modified.

An apparatus to measure a bore diameter typically consists of cylindrical “spindle” or “probe” that is a relatively close fit with the bore being measured. That probe will be supplied with pressurized air that can exit only through one or more ports at the outside surface of the probe. When the probe is inserted into the workpiece bore (or the workpiece placed on to a stationary probe) the air flow out of the port(s) will be restricted by the close fit (i.e. very small gap). That restricted air flow is correlated to the local diameter of the bore that is restricting the air flow. That correlation (often linear) is determined by a calibration with one or more master rings whose bore diameter is known a priori to a high degree of accuracy.

The advantage of measuring a bore diameter with an air gage is that it is generally more precise than any purely mechanical device for bore measurement. It tends to be used in situations where manufacturing tolerances are small and a high degree of measurement precision is required.

Although in theory an air gage can be made to measure a somewhat large range of diameter, there will generally be a loss of precision as the system is designed for a larger measuring range. Therefore, to provide the high level of precision that is generally required, an air gage is usually designed to operate over only a very small range of bore diameter usually less than 0.04 mm. This means that virtually every application of a different nominal diameter will require its own air gage probe made specifically for that nominal diameter. And as each measuring setup requires calibration with at least one (usually two, sometimes three) master rings, those master rings must all be accurately sized to fall within the very narrow operating range of that probe.

Therefore, each unique nominal diameter that is to be measured requires a dedicated probe and master ring(s). This is an expense that can usually only be justified in situations of medium to high production.

One example of a prior art gage that was made to be adjustable is U.S. Pat. No. 2,795,855, which is an air gage for measuring bores that has a variable gap restricting air flow. That air gap is not between the probe and the workpiece but rather between elements internal to the probe. One such element is adjustable by means of a screw thread to reach out to the bore wall of bores of varying diameter, and thus describes a probe with an adjustable diameter. However, that screw thread adjustment is imprecise, and the user must adjust first and then calibrate with dedicated master ring(s) that are unique to each nominal diameter that needs to be measured. This dependence on having the proper master ring(s) severely limits the flexibility of using such a system to measure any new size of bore that a manufacturer may need to measure. Also it is possible that the precision normally associated with air gage measurement of bores will be impaired by the fact that it must rely only on mechanical probe surface-to-bore surface contact, which must always rely on some amount of contact force.

For at least one or more of these reasons, or one or more other reasons, it would be advantageous if new or improved air gage systems could be developed, and/or improved methods of operation or implementation could be developed, so as to address any one or more of the concerns discussed above or to address one or more other concerns or provide one or more benefits.

### SUMMARY

Pneumatic comparator probes for engaging internal diameters of bores, pneumatic comparator systems capable of holding and facilitating precise adjustment of such pneumatic comparator probes, and methods of measuring the bore size of a workpiece are provided herein.

In at least a first aspect, a pneumatic comparator probe is provided that includes a probe body configured to contact a bore to be measured, a measuring component moveably connected to the probe body, and a variable separating mechanism moveably connected to the probe body. Movement of the variable separating mechanism adjusts a position of the measuring component in a direction of diametrical expansion relative to the probe body.

In at least a second aspect, a pneumatic comparator probe system is provided that includes a pneumatic comparator probe as described above with respect to the first aspect. The pneumatic comparator probe system also includes a gage unit that supplies the pressurized air to the measuring component. The gage unit includes a rigid framework to which the probe body is connected, and a movable measuring carriage, where the measuring component is attached to the measuring carriage. The gage unit also includes a control system that measures a characteristic representative of a flow rate of the pressurized air and determines a diameter of the workpiece at the location by comparison to one or more master rings having a known inside diameter.

In at least a third aspect, a method of measuring a bore size of a workpiece is provided. The method includes providing a pneumatic comparator probe system as described above with respect to the second aspect. The method also includes placing a workpiece to be measured on to the pneumatic comparator probe system such that a surface of a bore of the workpiece rests on the probe body at a location such that the bore contacts the probe body at a location that is diametrically opposite from the port of the measuring component. The method further includes supplying pressurized air by the gage unit to the port and passing the pressurized air through the port, measuring by the control unit a characteristic representative of a flow rate of the pressurized air passing through the port, and determining by the control unit the diameter of the workpiece at the location by comparison to one or more master rings having a known inside diameter.

### BRIEF DESCRIPTION OF THE DRAWINGS

Specific examples have been chosen for purposes of illustration and description, and are shown in the accompanying drawings, forming a part of the specification.

FIG. 1A illustrates a cross-sectional side view of one example of a pneumatic comparator probe of the present technology, with a first workpiece, taken along line A-A of FIG. 1B.

FIG. 1B illustrates a cross-sectional end view of the pneumatic comparator probe of FIG. 1A, taken along the line B-B of FIG. 1A.

FIG. 2A illustrates cross-sectional side view of the pneumatic comparator probe of FIG. 1, with a second workpiece, taken along line C-C of FIG. 2B.

FIG. 2B illustrates a cross-sectional end view of the pneumatic comparator probe of FIG. 2A, taken along the line D-D of FIG. 2A

FIG. 3 illustrates an enlarged view of a portion of the cross-sectional side view of the pneumatic comparator probe of FIG. 2A.

FIG. 4 illustrates a simplified version of the cross-sectional end view of the pneumatic comparator probe of FIG. 1B.

FIG. 5 illustrates one example of a pneumatic comparator system of the present technology.

FIG. 6 illustrates a cross-sectional end view of a second example of a pneumatic comparator probe of the present technology.

FIG. 7 illustrates a cross-sectional side view of a third example of a pneumatic comparator probe of the present technology.

FIG. 8 illustrates a cross-sectional side view of a fourth example of a pneumatic comparator probe of the present technology.

FIG. 9 illustrates a flow chart of one example of a method of measuring a bore size of a workpiece in accordance with the present technology.

While various embodiments discussed herein are amenable to modifications and alternative forms, aspects thereof have been shown by way of example in the drawings and are described in detail herein. It should be understood, however, that the disclosure is not limited to the particular embodiments described, and instead is meant to include all modifications, equivalents, and alternatives falling within the scope of the disclosure. In addition, the terms “example” and “embodiment” as used throughout this application is only by way of illustration, and not limitation, the Figures are not necessarily drawn to scale, and the use of the same reference symbols in different drawings indicates similar or identical items unless otherwise noted. Terms of direction as used herein, such as “vertical” and “horizontal”, as well as “top” and “bottom” are based on the orientation of the associated Figure as shown.

### DETAILED DESCRIPTION

Pneumatic comparator probes, also known as air gage probes, of the present technology may be used for engaging internal diameters of bores. Pneumatic comparator probes of the present technology are adjustable in diameter, and may thus be referred to as adjustable diameter pneumatic comparator probes, or adjustable diameter air gage probes. The diametrical adjustment is driven by a mechanism that accurately and precisely determines the adjustment amount, such that one probe can be calibrated at any diameter within a relatively wide range of the probe and then, after a precise adjustment, be used to measure accurately at any other diameter within the range of the probe.

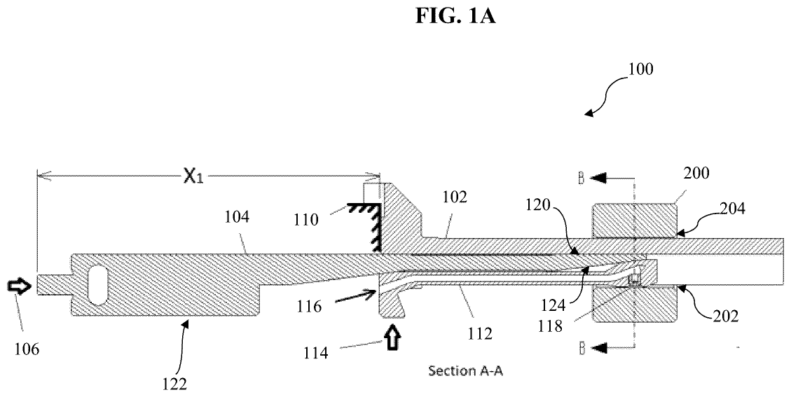

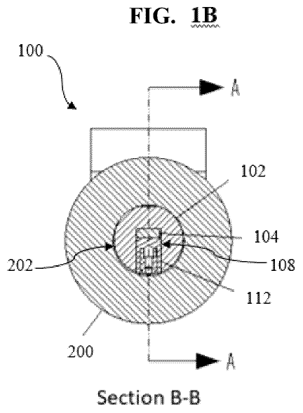

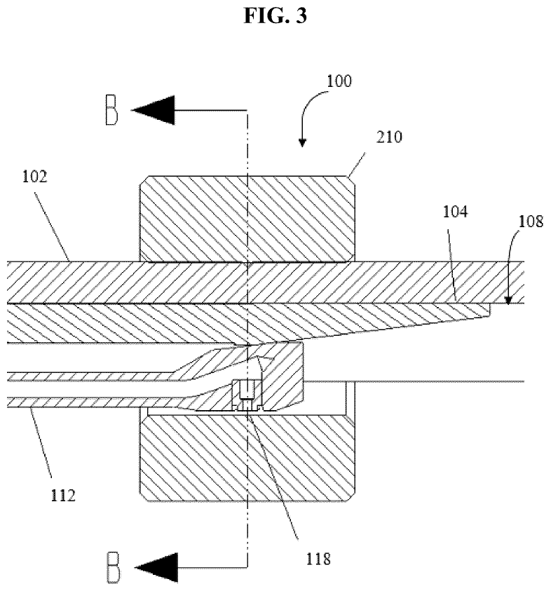

Generally, pneumatic comparator probes of the present technology include at least two parts that can be separated diametrically in a precise manner such as by a variable separating mechanism, such as a wedge. One embodiment of a pneumatic comparator probe 100 of the present technology is shown in FIGS. 1A, 1B, 2A, 2B, 3 and 4.

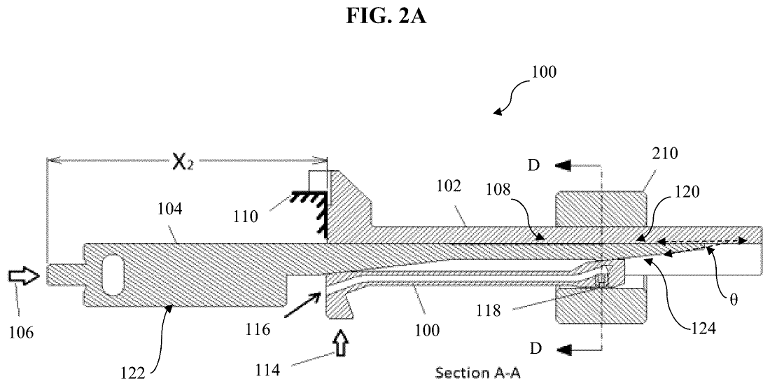

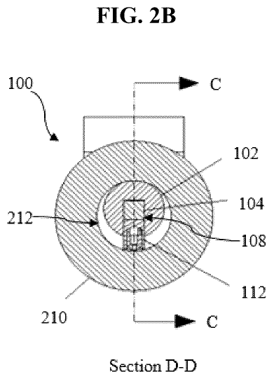

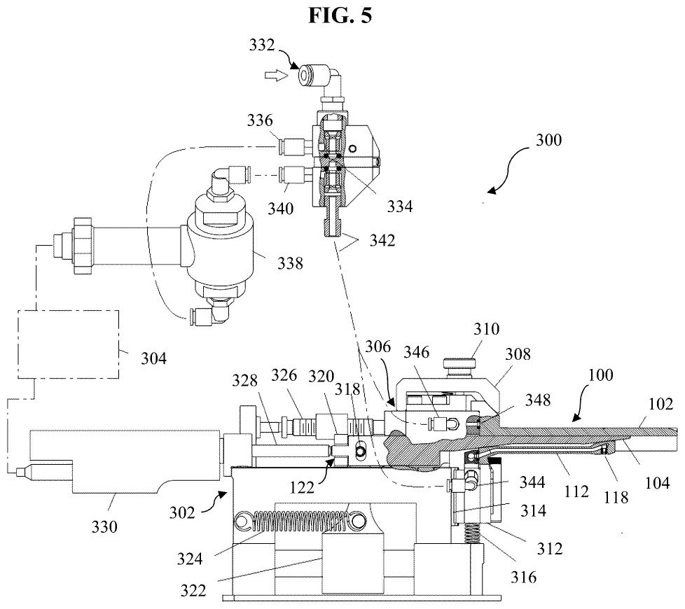

As shown in FIGS. 1A, 1B, 2A, 2B, 3 and 4, the pneumatic comparator probe 100 includes a probe body 102, which is installed to be firmly attached to a rigid ground structure 110 of the gage unit 302 (shown FIG. 5). The pneumatic comparator probe 100 includes a variable separating mechanism 104, which as shown is formed as a wedge at its wedge end 120, that can move in an axial direction 106 (shown in FIGS. 1A and 2A) within a channel 108 cut into the probe body 102. The position of the variable separating mechanism 104 results in a variable length of the rear end 122 of the variable separating mechanism 104 that extends from the probe body 102. In FIG. 1A, the variable length of the rear end 122 that is extending from the probe body 102 is labeled as being a first axial length X₁. A measuring component 112, which as shown is an elongate sensing finger, contacts the variable separating mechanism 104. The measuring component 112 may be part of a linear position transducer, and may be constrained by the gage unit 302 (FIG. 5) to move only in a direction perpendicular to the axial direction, which is shown as being a vertical direction 114. The gage unit 302 (FIG. 5) provides both upward force in the vertical direction 114 and precise axial positioning in the axial direction 106, so that probe body 102, variable separating mechanism 104 and measuring component 112 are held together consistently.

Referring to FIGS. 1A and 2A, the measuring component 112 includes a flow path 116 and an outlet port 118. During use of the pneumatic comparator probe 100, pressurized air is supplied from the gage unit 302 (FIG. 5) through the flow path 116 of the measuring component 112 to the outlet port 118. More specifically, the pressurized air passes through the flow path 116 of the measuring component 112 and exits the measuring component 112 at the outlet port 118.

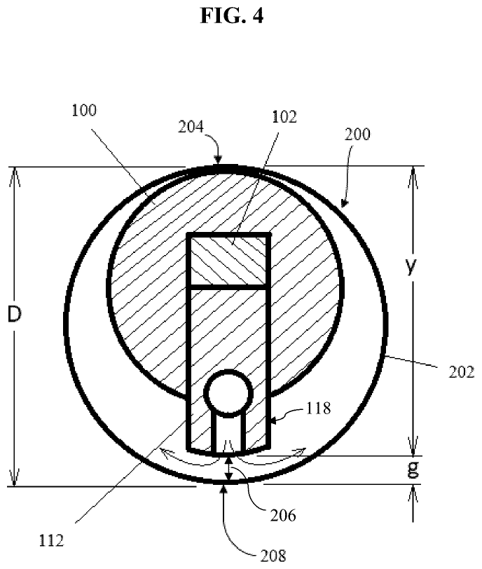

Referring to FIGS. 1A, 1B and 4, a first workpiece 200 has a first bore 202 to be measured. The first workpiece 200 is placed onto the pneumatic comparator probe 100 such that a bore contacting surface 204 of the first bore 202 rests on the probe body 102 such that the bore 202 contacts the probe body 102 at a location that is diametrically opposite from the outlet port 118. In examples where the pneumatic comparator probe 100 is horizontal, gravity may be employed to assist in making the bore 202 contact the probe body 102 at the desired location. In some examples, such as when the pneumatic comparator probe 100 is not horizontal, one or more physical support structures (not shown) may be used to assist in making the bore 202 contact the probe body 102 at the desired location.

FIG. 4 illustrates a simplified version of the cross-sectional end view of the pneumatic comparator probe of FIG. 1B. Referring to FIG. 4, at port 118 there is a gap 206 between the outlet port 118 and a bottom surface 208 of the bore 202 to be measured. This gap 206 restricts the escape of air from the port 118, and has a length g. The flow rate of the air escaping is measured either directly or indirectly within the gage unit 302 (FIG. 5). The flow rate is a function of the size of the gap 206 at the port 118, and thus translates mathematically to the diameter of the workpiece at that particular location, by comparison to one or more masters that has been measured in the same manner.

FIGS. 1A and 1B and 2A and 2B, respectively, are nearly identical except the workpiece 200 to be measured in FIG. 1 has been replaced in FIG. 2 by a second workpiece 210, which is substantially larger, and thus also has a second bore 212 that is larger than the first bore 202. In FIGS. 2A and 2B, the variable separating mechanism 104 has been moved axially so as to adjust the measuring component 112 to be in a position where it can be sufficiently close to the larger bore of the workpiece 210. And it can be seen that the second axial length X₂ dimension of FIG. 2 is shorter than the first axial length X₁ dimension shown in FIG. 1. The gage unit 302 (FIG. 5) (described later) will have a means to set and precisely measure axial length dimension, or at least, changes to that dimension. As best shown in FIG. 2A, the variable separating mechanism 104 necessarily has at least one wedge surface 124 at the wedge end 120 that is made to be a defined wedge angle θ from the top of the wedge which is coincident with the direction of the wedge's travel. Thus by mathematical calculation using the wedge angle θ and the difference in the axial length dimensions, a very accurate change in the diameter of the pneumatic comparator probe 100 can be known.

This is pertinent when the pneumatic comparator probe 100 is to be calibrated with one nominal size of master ring(s) and then subsequently adjusted to measure a different nominal size. To illustrate this, consider that the first workpiece 200 in FIG. 1 is instead a master ring of an accurately known inside diameter. When the pneumatic comparator probe 100 is adjusted to a new position, as in FIG. 2, the second workpiece 210 is known to be larger than the master ring by the aforementioned calculated difference, plus or minus any small amount that will be attributed to the change in flow rate of the air escaping at outlet port 118.

The basic mathematics of this pneumatic comparator probe 100 can be described with reference to FIG. 4, which is a simplified version of section B-B in FIG. 1B.

Geometrically, the diameter being measured (D), is simply the sum of physical probe diameter y of the pneumatic comparator probe 100, and the length of the gap 206 (air gap g) through which the pressurized air is escaping, as shown in the following equation:

D=y+g

The escaping air 214 has a flow rate q. The gap is a function of the flow rate q of the escaping air 214. The gage unit 302 (FIG. 5) that supplies the pressurized air has some means of measuring the flow rate or some other value related to flow rate. Typically, this can be from measuring the pressure drop across some orifice in the path of the air flow upstream from the pneumatic comparator probe 100, as shown in the following equation:

g=f(q)

This function of flow rate may be determined in several ways. It could be provided by the probe manufacturer, or determined as part of a calibration procedure that involves more than one size of calibration master rings. It often is very closely approximated by a linear function but it can be a more complex function. All this is commonly known and employed in prior art.

In all prior art, the probe is non-adjustable such that items 1, 2 and 3 are all one-piece. Thus, y, is just a fixed dimension.

It is best practice to calibrate with a master ring of accurately known diameter. The calibration diameter minus its associated gap is equal to, y, as is any bore diameter that will later be measured, minus its associated gap. This equivalence to y makes it unnecessary to know the value of y, as any two diameters minus their respective gaps will be equal to one another:

D_{cal}−g_{cal}=Dₘₑₐₛ−gₘₑₐₛ

Or

Dₘₑₐₛ=D_{cal}−(g_{cal}-gₘₑₐₛ)

The control system 304 of the gage unit 302 (FIG. 5) will have stored values for both the calibration size and gap, and it will be continually measuring the gap when any other bore is placed on to the gage probe. Thus the equation above is the basis for determining the diameter of any new bore placed on the pneumatic comparator probe 100.

In the present invention, the pneumatic comparator probe 100 includes three pieces where the variable separating mechanism 104 can be repositioned axially relative to the probe axis. This means that y is no longer a fixed dimension but rather is determined by the following equation:

$$y = c - x tan θ$$

$$And so :$$

$$D - g = c - x tan θ$$

$$Or$$

$$c = D - g + x tan θ$$

### Where:

θ is the wedge angle
x is axial position of the wedge (see X₁ in FIG. 1A and X₂ in FIG. 2A)
c is some unknown constant

It is not necessary that we know the value of c. Since we know it will be constant regardless of what is being measured, we again can compare the calibration values to the measuring values by their equivalence to c as follows:

$${D}_{m e a s} - {g}_{m e a s} + {x}_{m e a s} tan θ = {D}_{c a l} - {g}_{c a l} + {x}_{c a l} tan θ$$

$$Or$$

$${D}_{m e a s} = {D}_{c a l} - ( {g}_{c a l} - {g}_{m e a s} ) + ( {x}_{c a l} - {x}_{m e a s} ) tan θ$$

By this calculation the diameter of the bore being measured can be known accurately, even though it is being compared to a bore that could be substantially different in size. It should be noted that this last equation is different from what is used on traditional pneumatic bore gages only by the addition of the last term. The x distances as well as the wedge angle, θ, must be known with sufficient precision. Wedges are easily manufactured with precise and stable wedge angles. Linear distances can be precisely measured by various means such as linear displacement transducers.

FIG. 5 illustrates one example of a pneumatic comparator system 300 of the present technology, which is capable of holding and facilitating precise adjustment of a pneumatic comparator probe of the present technology, such as pneumatic comparator probe 100. The pneumatic comparator probe 100 may be installed in a gaging unit 302 capable of supplying the required air pressure, precisely measuring the air flow rate or associated value, and precisely controlling and/or measuring the linear position of the wedge.

As shown in FIG. 5, the probe body 102 of the pneumatic comparator probe 100 is clamped to a rigid framework 306 by clamp 308, held by clamp screw 310. Measuring component 112 is fixed to movable measuring carriage 312. As shown, the movable measuring carriage 312 may have a carriage slide 314, which is shown as being a linear carriage slide. In such examples, the movable measuring carriage 312 may have free motion in at least one direction, such as vertical, by means of the linear carriage slide 314. As the measuring component 112 must maintain contact with variable separating mechanism 104, the carriage slide 314 is biased toward the probe body 102, which is upward as shown, by carriage biasing spring 316.

A user may be able to position the variable separating mechanism 104 anywhere within its range of linear travel and once it is in the desired position it must remain there with no free play. To remove any free play, the variable separating mechanism 104 is held between a wedge biasing pin 318, and a wedge positioning fork 320. The wedge biasing pin 318 is attached to a wedge biasing slide 322 which is pulled by wedge biasing spring 324. The wedge positioning fork 320 is connected to a wedge positioning screw 326. The motion of the wedge positioning screw 326 is generally parallel to the motion of the variable separating mechanism 104. The means for rotating the wedge positioning screw 326 is not shown in the figure but may be any suitable device, such as a handwheel, knob, wrench or any other means common for rotating a positioning screw. The wedge biasing spring force is transmitted via the wedge biasing pin 318, forcing the wedge against the wedge positioning fork 320 which in turn transmits the force to the thread of the positioning screw 326. This keeps the screw thread continually loaded in one direction so that free play at the thread is not a concern. Although not shown in FIG. 5, the positioning screw 326 could optionally be driven by a motor with motion controlled by the control system 304 for the gage unit 302.

At least a portion of the rear end 122 of the variable separating mechanism 104 bears against a measuring component, shown as being sensing finger 328, of a device capable of measuring linear position such as a typical linear position transducer 330. Not shown is a typical spring internal to the linear position transducer to assure its continual contact with the variable separating mechanism 104.

Air that has been regulated to a constant pressure by any typical means, is supplied to supply port 332. The air flow passes through an assembly that contains a small air orifice 334. A common and very precise method of measuring air flow rate is to measure the air pressure change from the air passing through the air orifice 334. High pressure port 336 is connected by piping to the high-pressure side of differential pressure transducer 338, while low pressure port 340 is connected by piping to the low-pressure side of the same differential pressure transducer 338. As an alternate embodiment (not shown), pressure transducer 338 may be a single port pressure transducer connected only to air fitting 340. In this case, air fitting 336 would be either closed off or non-existent. Such an embodiment is possible only when the supplied air pressure is accurately known by some typical means (not shown).

Both the linear position transducer 330 and the differential pressure transducer 338 are electrically connected, such as by electrical cables, to the gage unit's control system 304. The electrical connection transmits both power for the devices and communication signals. The control system 304 may contain an integral user interface (not shown), e.g., touchscreen, or be connectable to a separate user interface.

The supplied air travels through piping 342 and enters an air fitting 344 on movable measuring carriage 312 where it is routed to the internal passage of measuring component 112. Optionally, the air traveling through piping 342 may be branched to also provide air to a secondary fitting 346, which delivers air to secondary air path 348. The probe body 102, shown in FIGS. 1 through 5, is of a style that may not require a secondary air path. However, an alternate probe style can be used that provide a secondary air path.

In some examples, it may be either not desired or can be problematic to have one side of the diameter of the probe make physical contact with the bore being measured while the other side of that diameter sensed by the flow-restrictive nature of the small gap between the port and the bore. If bores are relative long, even of moderate length, they could be cambered (bowed along their axis) or have local surface undulations such that a workpiece placed on the bore in a random orientation might not be making physical contact at that one point that is diametrically opposed to the port. This small separation of probe body and bore will constitute an unseen error in diameter measurement. However, there are several design variations that can be employed to improve the reliability of the measurement.

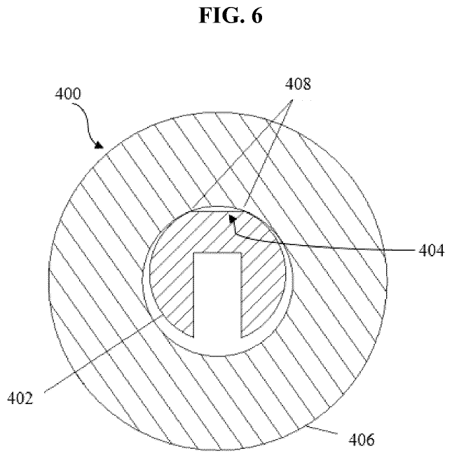

FIG. 6 illustrates one example of an alternative pneumatic comparator probe 400 of the present technology. The pneumatic comparator probe 400 has probe body 402 that has a bore contacting surface 404 that is truncated, and is thus flat, so that it will contact the bore 406 to be measured at two points of contact 408. The pneumatic comparator probe 400 may otherwise be the same as the pneumatic comparator probe 100 described above, and may be used in place of the pneumatic comparator probe 100 in a pneumatic comparator system 300 of FIG. 5. The modification of the probe body 402 having a truncated bore contacting 404 may cause the bore to shift downward very slightly relative to the probe body 402, with the amount of that shift dependent upon the radius curvature of the bore 406. This can be compensated for mathematically in the gage unit's control algorithm. This dual point of physical contact tends to have more physical stability improving the reliability of measurement. However, for long bores with camber this modification may not be sufficient, as there can be places in the bore where both theoretical points of contact on the probe body are held away from the bore wall by the contorted geometry of the bore.

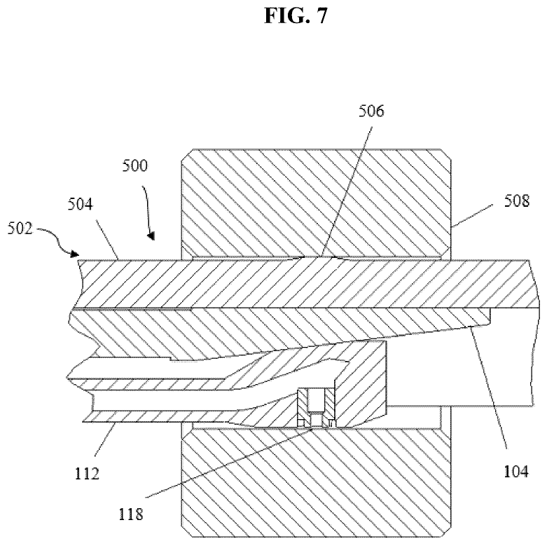

FIG. 7 illustrates another example of an alternative pneumatic comparator probe 500 of the present technology that may be used in examples having long bores with camber. In this embodiment, the probe body 502 has a relieved bore contacting surface 504, which may be formed by removing material as compared to the upper sidewall of the pneumatic comparator probe 100. The pneumatic comparator probe 500 may otherwise be the same as the pneumatic comparator probe 100 described above, and may be used in place of the pneumatic comparator probe 100 in a pneumatic comparator system 300 of FIG. 5. As shown, the relieved bore contacting surface 504 extends to a raised area 506 that is opposite of where the outlet port 118 is located. The raised area 506 is diametrically opposed to the outlet port 118 so that the bore 508 is virtually guaranteed to be in contact with the probe body 502 for all measuring locations in the bore.

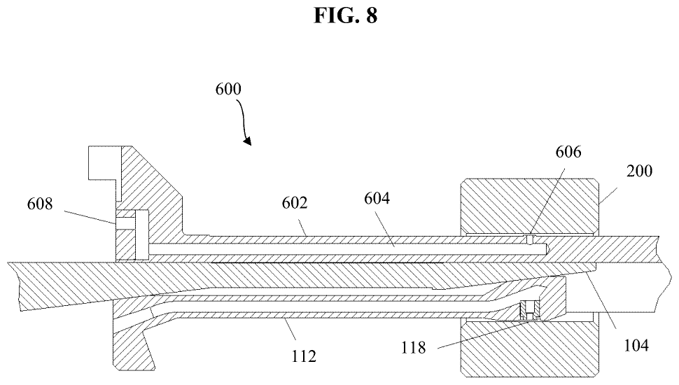

FIG. 8 illustrates another example of an alternative pneumatic comparator probe 600 of the present technology, which removes the need to have the bore in contact with the probe body 602. In this embodiment, probe body 602 has an internal air passage 604, which allows for delivery of a supply of air to a secondary port 606. The air is supplied to the probe body 602 at inlet port 608 which, when installed in the gage unit (302 of FIG. 5) connects to secondary air path 348 (in FIG. 5). The flow rate measured by the gage unit 302 (FIG. 5) is a function of the combined restrictions encountered at the outlet port 118 and the secondary port 606. This is a known technique, and in fact in prior art air gage probes commonly have more than one port, with the flow resistance sensed being due to the combined resistance at all ports. The pneumatic comparator probe 600 may otherwise be the same as the pneumatic comparator probe 100 described above, and may be used in place of the pneumatic comparator probe 100 in a pneumatic comparator system 300 of FIG. 5.

In that regard, the pneumatic comparator probe 600 will behave more like existing air gage probes inasmuch as they do not rely upon, nor even need, physical contact with the bore at the location of measurement. The avoidance of physical contact by the measuring instrument may be a desired feature for some users. Also, since bore-to-probe contact is not required, this particular embodiment no longer needs to be in a horizontal orientation (or have some other means of holding the bore to against the probe), and thus this could be used vertically or in any orientation.

Pneumatic comparator probes of the present technology, and pneumatic comparator systems using such pneumatic comparator probes of the present technology, as discussed above may provide one or more advantages over previously known pneumatic comparator systems and pneumatic comparator probes. For example, the use of one probe of the present technology and one master ring may be suitable for measuring a range of applications.

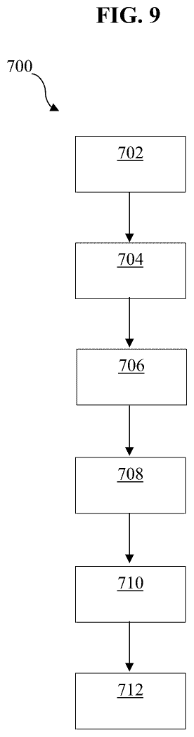

FIG. 9 illustrates one example of a method 700 of measuring a bore size of a workpiece in accordance with the present technology. The method 700 begins at step 702, with providing a pneumatic comparator probe system of the present technology. The method may be used with any pneumatic comparator probe of the present technology, such as the examples of such probes discussed above. The provided pneumatic comparator probe system may include a pneumatic comparator probe; a gage unit that supplies the pressurized air to the measuring component; a rigid framework to which the probe body is connected; a movable measuring carriage, where the measuring component is attached to the measuring carriage; and a control system that measures a flow rate of the pressurized air. The pneumatic comparator probe may include a probe body configured to contact a bore to be measured, a variable separating mechanism moveably connected to the probe; and a measuring component moveably connected to the probe body that contacts the variable separating mechanism. The measuring finger may include a port through which pressurized air passes when the pneumatic comparator probe is in use.

The method 700 may continue to step 704, which includes placing a workpiece to be measured on to the pneumatic comparator probe system such that a surface of a bore of the workpiece rests on the probe body at a location such that the bore contacts the probe body at a location that is diametrically opposite from the port of the measuring component.

The method 700 may continue to step 706, which includes supplying pressurized air by the gage unit to the port and passing the pressurized air through the port.

The method 700 may continue to step 708, which includes measuring by the control unit a characteristic representative of a flow rate of the pressurized air passing through the port.

The method 700 may continue to step 710, which includes measuring by the control unit a characteristic representative of the position of the measuring component relative to the probe body.

The method 700 may continue to step 712, which includes determining by the control unit the diameter of the workpiece at the location by comparison to one or more master rings having a known inside diameter.

In examples where the probe body includes a channel, and the variable separating mechanism moves in an axial direction within the channel, and the method may further include adjusting a position of the measuring component by axially moving the variable separating mechanism.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A pneumatic comparator probe comprising:
a probe body configured to contact a bore to be measured;
a measuring component moveably connected to the probe body, the measuring component including a port through which pressurized air passes when the pneumatic comparator is in use;
a variable separating mechanism moveably connected to the probe body;
wherein the movement of the variable separating mechanism adjusts a position of the measuring component in a direction of diametrical expansion relative to the probe body.

2. The pneumatic comparator probe of claim 1, wherein the probe body has a channel cut into the probe body, and the variable separating mechanism moves in an axial direction within the channel.

3. The pneumatic comparator probe of claim 1, wherein the variable separating mechanism is a wedge.

4. The pneumatic comparator probe of claim 1, wherein the probe body has a bore contacting surface that is truncated.

5. The pneumatic comparator probe of claim 1, wherein a relieved bore contacting surface of the probe body has a raised area that is diametrically opposed to the port.

6. The pneumatic comparator probe of claim 1, wherein the probe body includes an internal air passage and a secondary port through which secondary pressurized air passes when the pneumatic comparator probe is in use.

7. A pneumatic comparator probe system comprising:
a pneumatic comparator probe that includes:
a probe body configured to contact a bore to be measured;
a variable separating mechanism moveably connected to the probe body; and
a measuring component that contacts the variable separating mechanism, the measuring component including a port through which pressurized air passes when the pneumatic comparator probe is in use;
wherein movement of the variable separating mechanism adjusts a position of the measuring component in a direction of diametrical expansion relative to the probe body;
a gage unit that supplies the pressurized air to the measuring component and includes:
a rigid framework to which the probe body is connected;
a movable measuring carriage, where the measuring component is attached to the measuring carriage; and
a control system that measures a characteristic representative of a flow rate of the pressurized air and determines a diameter of the workpiece at the location by comparison to one or more master rings having a known inside diameter.

8. The pneumatic comparator probe system of claim 7, wherein the probe body has a channel cut into the probe body, and the variable separating mechanism moves in an axial direction within the channel.

9. The pneumatic comparator probe system of claim 8, wherein the control system measures a characteristic representative of the position of the measuring component relative to the probe body.

10. The pneumatic comparator probe system of claim 7, wherein the moveable measuring carriage is biased toward the probe body by a carriage biasing spring.

11. The pneumatic comparator probe system of claim 7, wherein the variable separating mechanism is a wedge.

12. The pneumatic comparator probe system of claim 11, wherein the gage unit further comprises:
a wedge biasing slide that is pulled by a wedge biasing spring, wherein a wedge biasing pin is attached to the wedge biasing slide; and
a wedge positioning fork connected to a wedge positioning screw;
wherein the wedge is held between the wedge biasing pin and the wedge positioning fork, and a spring force of the wedge biasing spring is transmitted to the wedge via the wedge biasing pin, forcing the wedge against the wedge positioning fork, which in turn transmits the force to the wedge positioning screw.

13. The pneumatic comparator probe system of claim 12, wherein the positioning screw is driven by a motor controlled by the control system.

14. The pneumatic comparator probe system of claim 12, wherein an end surface of the wedge bears against a measuring component of a linear position transducer.

15. The pneumatic comparator probe system of claim 7, wherein the probe body has a bore contacting surface that is truncated.

16. The pneumatic comparator probe system of claim 7, wherein a relieved bore contacting surface of the probe body has a raised area that is diametrically opposed to the port.

17. The pneumatic comparator probe system of claim 7, wherein the probe body includes an internal air passage and a secondary port through which secondary pressurized air passes when the pneumatic comparator probe is in use.

18. A method of measuring a bore size of a workpiece, the method comprising:
providing a pneumatic comparator probe system, wherein the pneumatic comparator probe system includes:
a pneumatic comparator probe that includes:
a probe body configured to contact a bore to be measured;
a variable separating mechanism moveably connected to the probe; and
a measuring component moveably connected to the probe body that contacts the variable separating mechanism, the measuring component including a port through which pressurized air passes when the pneumatic comparator probe is in use;
a gage unit that supplies the pressurized air to the measuring component;
a rigid framework to which the probe body is connected;
a movable measuring carriage, where the measuring component is attached to the measuring carriage; and
a control system that measures a flow rate of the pressurized air
placing a workpiece to be measured on to the pneumatic comparator probe system such that a surface of a bore of the workpiece rests on the probe body at a location such that the bore contacts the probe body at a location that is diametrically opposite from the port of the measuring component;
supplying pressurized air by the gage unit to the port and passing the pressurized air through the port;
measuring by the control unit a characteristic representative of a flow rate of the pressurized air passing through the port;
measuring by the control unit a characteristic representative of the position of the measuring component relative to the probe body; and
determining by the control unit the diameter of the workpiece at the location by comparison to one or more master rings having a known inside diameter.

19. The method of claim 18, wherein the probe body includes a channel, and the variable separating mechanism moves in an axial direction within the channel, and the method further comprises:
adjusting a position of the measuring component by axially moving the variable separating mechanism.
